(19) United States
(12) Patent Application Publication
(10) Pub. No.: US 2016/0369791 A1
(43) Pub. Date: Dec. 22, 2016

(54) HIGH PRESSURE PUMP

(71) Applicant: DENSO CORPORATION, Kariya-city (JP)

(72) Inventors: Shinichiro KOSHIMOTO, Kariya-city (JP); Kaoru ODA, Kariya-city (JP)

(21) Appl. No.: 15/188,118

(22) Filed: Jun. 21, 2016

(30) Foreign Application Priority Data
Jun. 22, 2015 (JP) 2015-124878

(51) Int. Cl. F04B 53/10; F04B 17/03; F04B 53/16; F04B 53/14; F02M 37/04; F02M 37/08; F04B 9/04; F04B 17/05

(52) U.S. Cl. CPC F04B 53/10; F04B 9/042; F04B 17/03; F04B 17/05; F04B 53/14; F02M 37/043; F02M 37/08; F04B 53/16

(57) ABSTRACT

A high pressure pump includes a pressurization portion, a discharge portion, a body portion, a valve member, a holding member, and an urging member. The body portion includes a relief passage defining portion, an inlet defining portion, a valve seat, and an outlet defining portion. An outlet of the body portion is located apart in a separation direction from an inlet of the body portion. The valve member includes an outer wall surface closing the outlet of the body portion. When the valve member contacts the valve seat, a first distance between an edge portion of the outer wall surface of the valve member facing in a contact direction and an edge portion of the outlet defining portion facing in the contact direction is larger than a second distance between the valve member and the holding member.

### CROSS REFERENCE TO RELATED APPLICATION

This application is based on and incorporates herein by reference Japanese Patent Application No. 2015-124878 filed on Jun. 22, 2015.

### TECHNICAL FIELD

The present disclosure relates to a high pressure pump.

### BACKGROUND

Conventionally, a high pressure pump sending a high pressure fuel is known as a pump supplying fuel to an engine. A passage, which stores the high pressure fuel sent from the high pressure pump, is a fuel rail. Since a pressure in the fuel rail is maintained, the fuel having a high pressure is injected from an injector.

However, a failure of an adjustment valve included in the high pressure pump, for example, may cause an extraordinary high pressure higher than an acceptable range in the fuel rail, and the fuel rail and the injector may be damaged. A high pressure pump including a relief valve, which is opened when a pressure in a fuel rail extraordinarily increases, has been proposed in Patent Document 1 (JP 2009-114868 A). In the high pressure pump described in Patent Document 1, a valve member is urged by an urging member toward a valve seat, and accordingly the valve member closes the relief valve. When the pressure in the fuel rail extraordinarily increases, the relief valve is opened, and accordingly the pressure in the fuel rail can be decreased.

In the high pressure pump described in Patent Document 1, the pressure in the fuel rail decreases after the valve member opens the relief valve for a while, and an urging force becomes larger than a force of the pressure that pushes the valve member to open the relief valve. Therefore, the relief valve once opened is closed, and the relief valve is not opened again unless the pressure in the fuel rail increases up to a predetermined value. Consequently, the pressure in the fuel rail may extraordinarily increase constantly, and accordingly the fuel rail and the injector may be damaged.

### SUMMARY

It is an objective of the present disclosure to provide a high pressure pump preventing a pressure in a fuel rail from extraordinarily increasing constantly after a relief valve is opened once.

According to a first aspect of the present disclosure, a high pressure pump includes: a pressurization portion including a pressurization room whose volume is varied by a motion of a plunger to be capable of pressurizing a fuel; a discharge portion discharging the fuel pressurized in the pressurization room to a downstream passage that is a space on a downstream side of the discharge portion; a body portion including a relief passage defining portion, an inlet defining portion, a valve seat, and an outlet defining portion; a valve member reciprocatably provided in the body portion, an outer wall of the valve member slidably contacting an inner wall of the body portion, the valve member contacting the valve seat so as to close the inlet of the body portion when a pressure in the downstream passage is below a predetermined pressure, the valve member moving apart from the valve seat in a separation direction so as to open the inlet of the body portion when the pressure in the downstream passage is at or above the predetermined pressure; a holding member positioned apart in the separation direction by a second distance from the valve member when the valve member contacts the valve seat, an outer wall of the holding member contacting the inner wall of the body portion; and an urging member having a first end contacting the valve member and a second end contacting the holding member, the urging member urging the valve member toward the valve seat. The relief passage defining portion defines a relief passage through which the fuel flows from the downstream passage to an upstream passage that is a space on an upstream side of the discharge portion. The inlet defining portion defines an inlet through which the relief passage and the downstream passage communicate with each other. The valve seat is provided on a radially outer side of the inlet and has an annular shape. The outlet defining portion defines an outlet through which the relief passage and the upstream passage communicate with each other. The outlet of the body portion is located apart in the separation direction from the inlet of the body portion. The valve member includes an outer wall surface closing the outlet of the body portion. When the valve member contacts the valve seat, a first distance between an edge portion of the outer wall surface of the valve member facing in a contact direction opposite from the separation direction and an edge portion of the outlet defining portion facing in the contact direction is larger than the second distance between the valve member and the holding member.

According to this, when the pressure in the downstream passage increases extraordinarily, the valve member move apart from the valve seat and opens the inlet. After the inlet is opened, the holding member is pushed in the separation direction by the valve member until the outlet is opened. Subsequently, the outlet is opened. Accordingly, a force of the urging member pushing the valve member in the contact direction becomes weak. Consequently, the valve member becomes easy to be moved by the pressure in the downstream passage after the outlet is once opened.

According to another aspect of the present disclosure, a high pressure pump includes: a pressurization portion including a pressurization room whose volume is varied by a motion of a plunger to be capable of pressurizing a fuel; a discharge portion discharging the fuel pressurized in the pressurization room to a downstream passage that is a space on a downstream side of the discharge portion; a body portion including a relief passage defining portion, an inlet defining portion, a valve seat, and an outlet defining portion; a valve member reciprocatably provided in the body portion, an outer wall of the valve member slidably contacting an inner wall of the body portion, the valve member contacting the valve seat so as to close the inlet of the body portion when a pressure in the downstream passage is below a predetermined pressure, the valve member moving apart from the valve seat in a separation direction so as to open the inlet of the body portion when the pressure in the downstream passage is at or above the predetermined pressure; a holding member positioned apart in the separation direction by a second distance from the valve member when the valve member contacts the valve seat, an outer wall of the holding member contacting the inner wall of the body portion; and an urging member having a first end contacting the valve member and a second end contacting the holding member, the urging member urging the valve member toward the valve seat. The relief passage defining portion defines a relief passage through which the fuel flows from the downstream passage to an upstream passage that is a space on an upstream side of the discharge portion. The inlet defining portion defines an inlet through which the relief passage and the downstream passage communicate with each other. The valve seat is provided on a radially outer side of the inlet and has an annular shape. The outlet defining portion defines an outlet through which the relief passage and the upstream passage communicate with each other. The outlet of the body portion is located apart in the separation direction from the inlet of the body portion. The valve member includes an outer wall surface closing the outlet of the body portion. When the valve member contacts the valve seat, a distance between an edge portion of the outer wall surface facing in the contact direction and an edge portion of the outlet defining portion facing in the contact direction is defined as a first distance, and a length of the urging member in the urging direction is defined as a first length. When the urging member is fully compressed, a length of the urging member in the urging direction is defined as a second length. The first distance is larger than a difference between the first length and the second length.

According to this, when the pressure in the downstream passage increases extraordinarily, the valve member move apart from the valve seat and opens the inlet. The outlet is not opened even when the urging member is fully compressed after the inlet is opened, and the fuel in the downstream passage keeps being prevented from flowing into the upstream passage. Therefore, a force is put on the urging member by the pressure of the fuel in the downstream passage even after the urging member is fully compressed. Accordingly, the urging member is broken and a power of the urging member pushing the valve member in the contact direction becomes weak. Consequently, the valve member becomes easy to be moved by the pressure in the downstream passage after the outlet is once opened.

### BRIEF DESCRIPTION OF THE DRAWINGS

The disclosure, together with additional objectives, features and advantages thereof, will be best understood from the following description, the appended claims and the accompanying drawings, in which:

FIG. 1 is a block diagram illustrating a high pressure pump according to a first embodiment of the present disclosure,

FIG. 2 is a diagram illustrating a pressure adjustment portion according to the first embodiment,

FIG. 3 is a diagram illustrating a pressure adjustment portion when a valve member thereof is closed according to a second embodiment of the present disclosure,

FIG. 4 is a diagram illustrating the pressure adjustment portion when the valve member thereof is open according to the second embodiment,

FIG. 5 is a diagram illustrating a pressure adjustment portion according to a third embodiment of the present disclosure, and

FIG. 6 is a diagram illustrating a pressure adjustment portion according to a modification of the present disclosure.

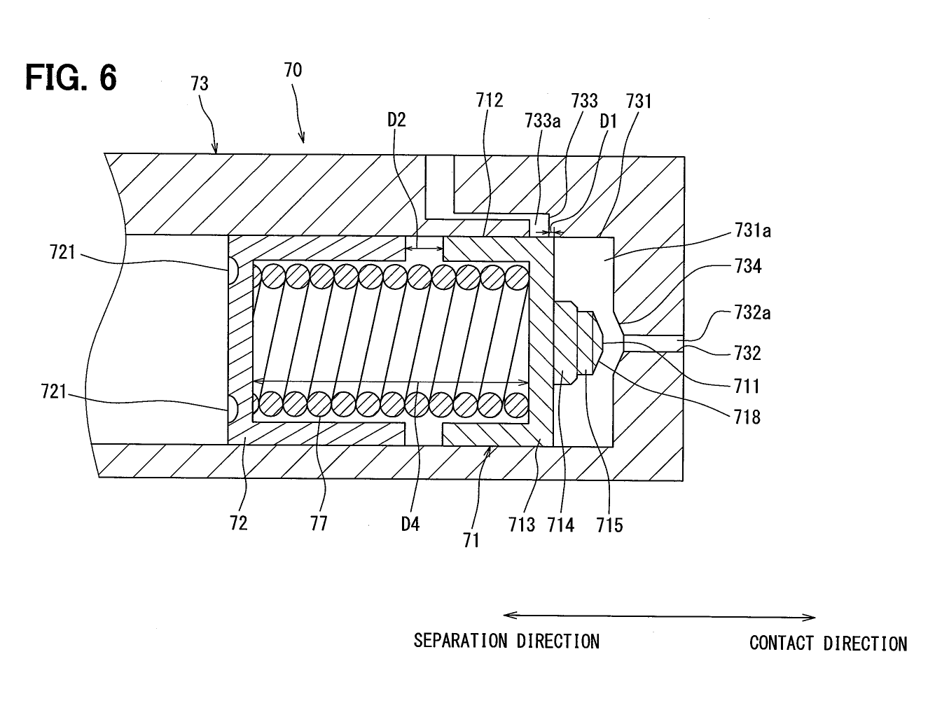

### DETAILED DESCRIPTION

Embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined.

The embodiments may be partially combined even if it is not explicitly described that the embodiments can be combined, provided there is no harm in the combination.

### First Embodiment

A low pressure pump 31 pumping up a fuel is provided in a fuel tank 30 in which the fuel is stored. The low pressure pump 31 is driven by an electric motor that uses a battery as a power source. The fuel discharged from the low pressure pump 31 is supplied to a high pressure pump 10 through a low pressure passage 33. The low pressure passage 33 is an upstream passage in the present embodiment. The high pressure pump 10 according to the present embodiment is installed in a vehicle.

The high pressure pump 10 is a pump that includes a plunger 41 reciprocating in a pressurization room 42 having a circular cylindrical shape. The high pressure pump 10 draws and discharges a fuel by the reciprocation of the plunger 41. The plunger 41 is driven by a rotation of a cam 43 integrated with a camshaft 44 of an engine. An adjustment valve 50 is provided on an intake side of the high pressure pump 10. The adjustment valve 50 is a normally open type solenoid valve. In an intake process of the high pressure pump 10, the adjustment valve 50 is open, and a fuel is drawn into the pressurization room 42. The plunger 41 moves downward in the intake process. In a discharge process of the adjustment valve 50, a control portion controls a close period of the adjustment valve 50 to adjust an amount of a fuel discharged from the high pressure pump 10, and accordingly a fuel pressure (discharge pressure) is controlled. The plunger 41 moves upward in the discharge process. The control portion may control a valve close period corresponding to a range of a crankshaft position which is from a valve close timing, at which the adjustment valve 50 is closed, to a top dead center of the plunger 41. The plunger 41, the pressurization room 42, the cam 43 and the camshaft 44 are included in a pressurization portion 40. When the fuel pressure is increased, the valve close timing (energization timing) of the adjustment valve 50 is set early so that the valve close period of the adjustment valve 50 is long, and accordingly the amount of the fuel discharged from the high pressure pump 10 is increased. When the fuel pressure is decreased, the valve close timing of the adjustment valve 50 is set late so that the valve close period of the adjustment valve 50 is short, and accordingly the amount of the fuel discharged from the high pressure pump 10 is decreased.

A discharge portion 60 preventing a discharged fuel from flowing back is provided on an outlet side of the high pressure pump 10. A fuel pressurized in the pressurization room 42 of the high pressure pump 10 is discharged from the discharge portion 60. The fuel discharged from the discharge portion 60 is sent to a fuel rail (high pressure fuel passage) 20 through a high pressure passage 34, and the fuel in the fuel rail 20 is distributed to an injector 21 attached to each cylinder of an engine. The high pressure passage 34 is a downstream passage in the present embodiment.

The high pressure pump 10 further includes a fuel return passage 90 through which the fuel in the high pressure passage 34 and the fuel rail 20 is returned to the low pressure passage 33. A pressure adjustment portion 70 is provided in the fuel return passage 90. The pressure adjustment portion 70 includes valve member 71 that is opened when a fuel pressure in the high pressure passage 34 is a predetermined upper limit pressure (25 MPa, for example).

According to this configuration, when the fuel pressure in the high pressure passage 34 is higher than the upper limit pressure during an engine (the high pressure pump 10) driving, the valve member 71 is opened so that the fuel pressure in the high pressure passage 34 and the fuel in the fuel rail 20 is maintained to be below the upper limit pressure.

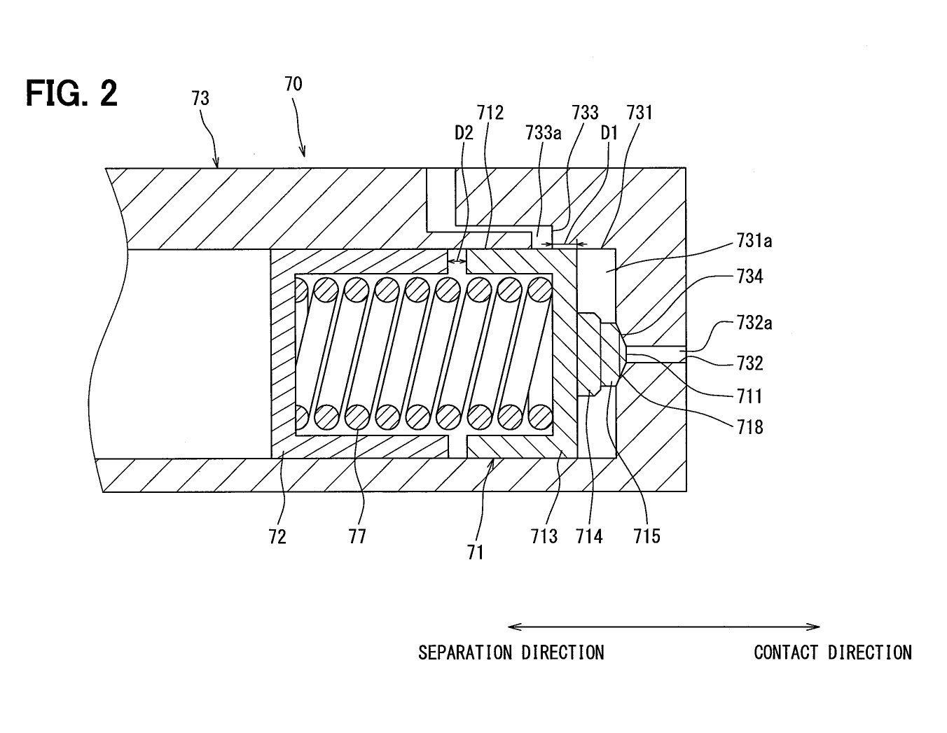

Next, the pressure adjustment portion (relief valve) 70 of the present embodiment will be described below referring to FIG. 2. The pressure adjustment portion 70 includes a body portion 73, a valve member 71, an urging member 77 and a holding member 72.

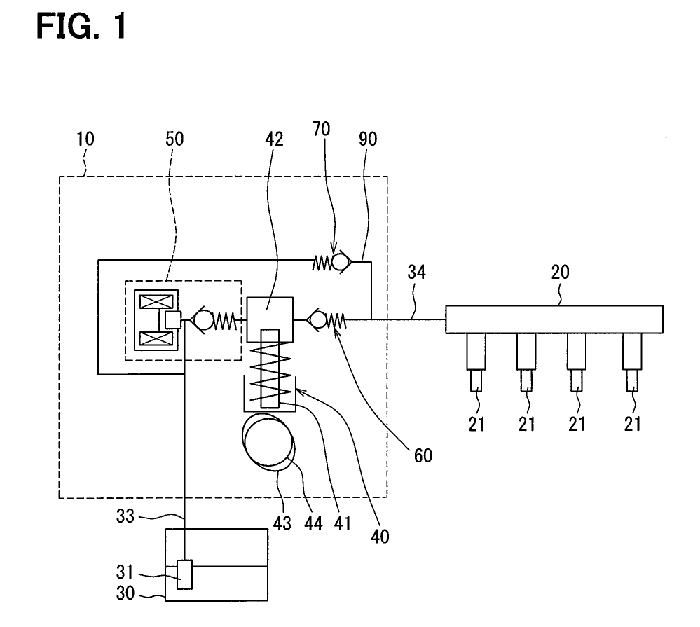

The body portion 73 has a bottomed and circular cylindrical shape. The body portion 73 is made of stainless steel, for example. The body portion 73 defines a relief passage 731a in a cylinder portion thereof. The body portion 73 defines, in a bottom portion thereof closing one end of the cylinder portion, an inlet 732a through which the relief passage 731a and the high pressure passage 34 illustrated in FIG. 1 communicate with each other. The high pressure passage 34 is a space on a downstream side. The body portion 73 defines, in the cylinder portion, an outlet 733a through which the relief passage 731a and the low pressure passage 33 illustrated in FIG. 1 communicate with each other. The low pressure passage 33 is a space on an upstream side.

Specifically, the body portion 73 includes, in the cylinder portion thereof, a passage defining portion (relief passage defining portion) 731 that defines the relief passage 731a and an outlet defining portion 733 defining the outlet 733a. Moreover, the body portion 73 includes, in the bottom portion, an inlet defining portion 732 defining the inlet 732a.

In the present embodiment, the inlet defining portion 732 is a wall surface of the bottom portion of the body portion 73 defining the inlet 732a. The outlet defining portion 733 is an inner wall surface of the cylinder portion of the body portion 73 defining the outlet 733a. The passage defining portion 731 is a wall surface of the cylinder portion of the body portion 73 defining the relief passage 731a.

The inlet 732a, the relief passage 731a and the outlet 733a are arranged in this order from the downstream side. In the present embodiment, the inlet 732a is provided in a surface intersecting with (perpendicular to) an axis of the body portion 73. The outlet 733a is provided in a surface that is along an axial direction of the body portion 73. The relief passage 731a is defined by an inner wall surface that is along the axial direction of the body portion 73.

A valve seat 734 extending from an end portion of the inlet defining portion 732 on the upstream side toward a radially outer side is provided on the bottom portion of the body portion 73. The valve seat 734 may have an annular shape on the radially outer side in the end portion of the inlet defining portion 732.

The valve member 71, the urging member 77 and the holding member 72 are provided inside the body portion 73. The valve member 71 contacts the valve seat 734. A first end of the urging member 77 is fixed to (contacts) a surface of the valve member 71 opposite from a surface of the valve member 71 contacting the valve seat 734 and urges the valve member 71 toward the valve seat 734. A second end of the urging member 77 opposite from the first end fixed to the valve member 71 is fixed to (contacts) the holding member 72.

The valve member 71 comes into and out of contact with the valve seat 734 according to the fuel pressure in the high pressure passage 34. In the present embodiment, a direction in which the valve member 71 moves apart from the valve seat 734 is a separation direction, and a direction opposite to the separation direction is a contact direction. In the present embodiment, the separation direction is the same direction as an upstream direction. The contact direction is the same direction as a downstream direction. The holding member 72 may be movable in the separation direction.

The valve member 71 includes a front end portion 715, a medium portion 714 and an outer wall portion 713. The valve member 71 is made of stainless steel, for example. The front end portion 715, the medium portion 714 and the outer wall portion 713 are provided in this order from the contact direction toward the separation direction. The front end portion 715, the medium portion 714 and the outer wall portion 713 may be arranged in this order from the downstream side.

A diameter of the outer wall portion 713 is larger than a diameter of the medium portion 714. The diameter of the medium portion 714 is larger than a diameter of the front end portion 715.

The front end portion 715 includes a pressure receive surface 711 and a seating portion (valve seat portion) 718. The seating portion 718 contacts the valve seat 734, and accordingly the valve member 71 closes the inlet 732a. Specifically, when the valve member 71 contact the valve seat 734, the pressure receive surface 711 closes the inlet 732a. An area of the pressure receive surface 711 is equal to or less than one tenth of an area of the outer wall portion 713.

In the present embodiment, the outer wall portion 713 has a bottomed and circular cylindrical shape, for example. The outer wall portion 713 includes an outer wall surface 712 slidably contacting (sliding on) the passage defining portion 731. Therefore, a fuel is prevented from flowing between the passage defining portion 731 and the outer wall surface 712.

In the present embodiment, a spring (coil spring) is used as the urging member 77. The first end of the urging member 77 is fixed to an inner wall surface of the outer wall portion 713 of the valve member 71. The urging member 77 urges the valve member 71 toward the valve seat 734.

In the present embodiment, the holding member 72 has a bottomed and circular cylindrical shape. The holding member 72 is press-fitted to the body portion 73 so that an outer wall of the holding member 72 contacts an inner wall surface of the body portion 73. The holding member 72 is positioned apart by a predetermined distance from the valve member 71 when the valve member 71 contacts the valve seat 734. The second end of the urging member 77 opposite from the first end fixed to the valve member 71 is fixed to the holding member 72. The predetermined distance may be a distance (second distance) D2.

The urging member 77 has a power stretching in an axial direction. Therefore, the valve member 71 is urged toward the valve seat 734 by the urging member 77. When a pressure of a fuel in the high pressure passage 34 communicating with the inlet 732a is below a predetermined pressure, the valve member 71 closes the inlet 732a by an urging force of the urging member 77. In other words, when the pressure of the fuel in the high pressure passage 34 communicating with the inlet 732a is at or above the predetermined pressure, the valve member 71 moves apart from the valve seat 734 and opens the inlet 732a.

The valve member 71 contacts the valve seat 734 in FIG. 2. In this situation, a distance (first distance) D1 between an edge portion of the outlet defining portion 733 facing in the contact direction and an edge portion of the outer wall surface 712 facing in the contact direction is larger than the distance (second distance) D2 between an edge portion of the holding member 72 facing in the contact direction and an edge portion of the valve member 71 facing in the separation direction. The distance D1 may be between an edge portion of an opening of the outlet 733a on a side in the contact direction and the edge portion of the outer wall surface 712 facing in the contact direction.

Accordingly, when the pressure of the fuel in the downstream side (high pressure passage 34) communicating with the inlet 732a exceeds the predetermined pressure, and when the valve member 71 moves in the separation direction from the valve seat 734, the fuel flowing from the high pressure passage 34 through the inlet 732a is prevented from flowing into the outlet 733a until the holding member 72 contacts the valve member 71. Therefore, the pressure of the fuel in the high pressure passage 34 communicating with the inlet 732a is maintained, and accordingly the pressure of the fuel causing the valve member 71 to move in the separation direction is maintained. Accordingly, the holding member 72 is pushed by the valve member 71 according to the motion of the valve member 71 in the separation direction, and the holding member 72 also moves in the separation direction. Subsequently, the inlet 732a communicates with the outlet 733a, and the fuel from the high pressure passage 34 flows into the low pressure passage 33 through the outlet 733a. Consequently, the pressure of the fuel in the high pressure passage 34 is decreased. The inlet 732a is an inlet through which the fuel flows into the pressure adjustment portion 70, and the outlet 733a is an outlet through which the fuel flows out of the pressure adjustment portion 70.

Effects of the high pressure pump 10 according to the present embodiment will be described below.

The high pressure pump 10 includes the pressurization portion 40, the discharge portion 60, the body portion 73, the valve member 71, the holding member 72 and the urging member 77. The pressurization portion 40 includes the plunger 41. The pressurization portion 40 includes (defines) the pressurization room 42 whose volume is varied by a motion of the plunger 41, and accordingly the fuel can be pressurized in the pressurization room 42. The discharge portion 60 discharges the fuel pressurized in the pressurization room 42 into the high pressure passage 34 that is a space on the downstream side of the discharge portion 60.

The body portion 73 includes the passage defining portion (relief passage defining portion) 731, the inlet defining portion 732, the valve seat 734 and the outlet defining portion 733. The passage defining portion 731 defines the relief passage 731a through which a fuel flows from the high pressure passage 34 to the low pressure passage 33 that is a space on the upstream side of the discharge portion 60. The inlet defining portion 732 defines the inlet 732a through which the relief passage 731a and the high pressure passage 34 communicate with each other. The valve seat 734 having an annular shape is provided on the radially outer side of the inlet 732a. The valve seat 734 may continue from the inlet 732a. The outlet defining portion 733 defines the outlet 733a through which the relief passage 731a and the low pressure passage 33 communicate with each other. The relief passage 731a is located between the inlet 732a and the outlet 733a. The valve member 71 is reciprocably provided in the body portion 73, and an outer wall of the valve member 71 slidably contacts the inner wall of the body portion 73. The valve member 71 closes the inlet 732a by contacting the valve seat 734. When the pressure in the high pressure passage 34 is at or above the predetermined pressure, the valve member 71 moves apart from the valve seat 734 and opens the inlet 732a. The holding member 72 is provided apart in the separation direction by a predetermined distance from the valve member 71 that contacts the valve seat 734. The outer wall of the holding member 72 contacts the inner wall of the body portion 73. The first end of the urging member 77 contacts the valve member 71, and the second of the urging member 77 contacts the holding member 72. The urging member 77 urges the valve member 71 toward the valve seat 734. The outlet 733a is located apart in the separation direction from the inlet 732a. The valve member 71 includes the outer wall surface 712 closing the outlet 733a. When the valve member 71 contacts the valve seat 734, the distance D1 between the edge portion of the outlet defining portion 733 facing in the contact direction and the edge portion of the outer wall surface 712 facing in the contact direction is larger than the distance D2 between the edge portion of the holding member 72 facing in the contact direction and the edge portion of the valve member 71 facing in the separation direction.

According to this configuration, when the pressure of the fuel in the high pressure passage 34 is extraordinary high, the valve member 71 moves apart from the valve seat 734 and opens the inlet 732a. The valve member 71 pushes the holding member 72 until the outlet 733a is opened after the inlet 732a is opened. Subsequently, the outlet 733a is opened, and accordingly a force of the urging member 77 urging the valve member 71 toward the valve seat 734 becomes weak. Consequently, the pressure adjustment portion 70 becomes easy to be opened by the pressure of the fuel in the high pressure passage 34 after the pressure adjustment portion 70 is once opened. The valve member 71 may become easy to move apart from the valve seat 134 by the pressure of the fuel in the high pressure passage 34 after the holding member 72 is once moved by the valve member 71.

### Second Embodiment

In a second embodiment, when a valve member 71 contacts a valve seat 734, a distance D2 between an edge portion of a holding member 72 facing in the contact direction and the edge portion of the valve member 71 facing in a separation direction is larger than a distance D1 between an edge portion of an outlet defining portion 733 facing in the contact direction and an edge portion of an outer wall surface 712 facing in the contact direction.

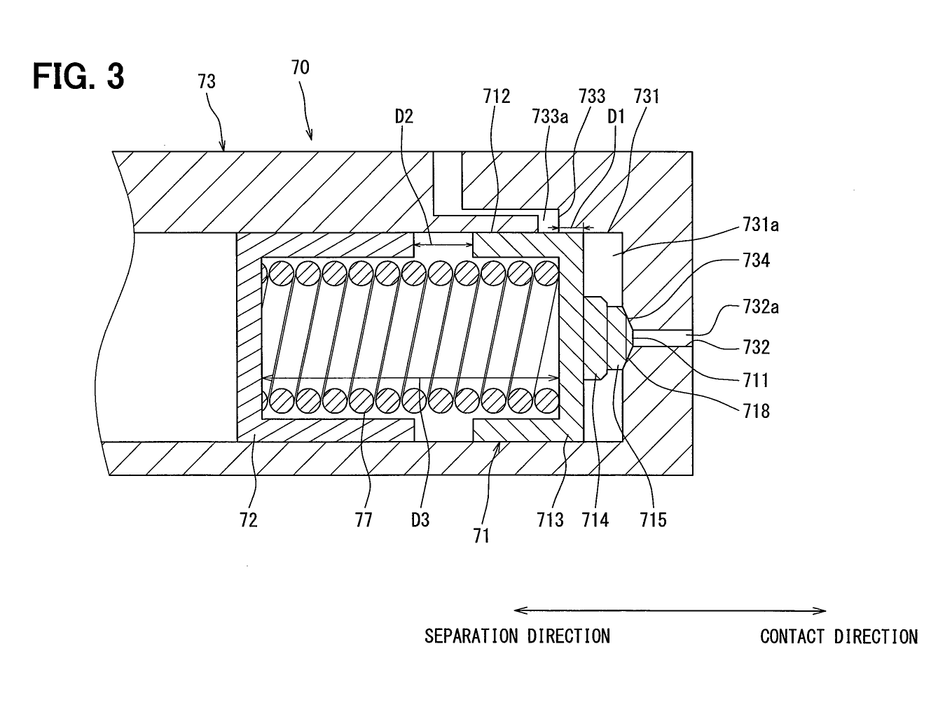

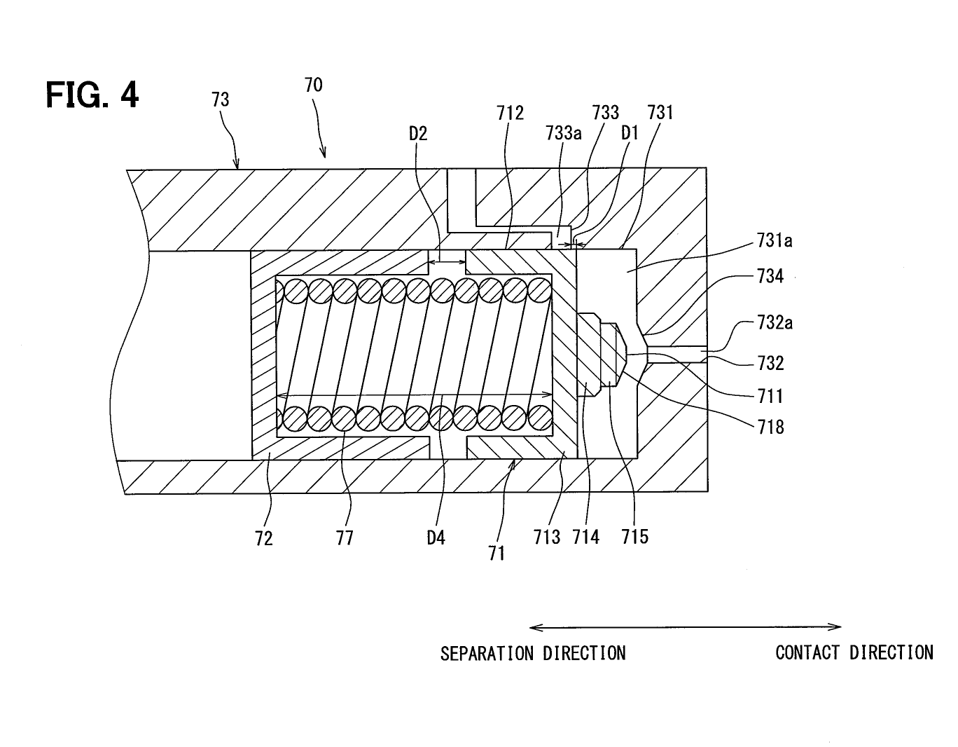

When the valve member 71 contacts the valve seat 734 as shown in FIG. 3, a length of an urging member 77 is defined as a length (first length) D3. When the valve member 71 is apart from the valve seat 734, and when the urging member 77 is fully compressed as shown in FIG. 4, a length of the urging member 77 is defined as a compressed length (second length) D4. The distance D1 is larger than a difference between the length D3 and the compressed length D4. In other words, D1>D3−D4. A spring (coil spring) may be used as an example of the urging member 77, and the compressed length D4 may be a solid length of the spring.

Effects of a high pressure pump 10 of the present embodiment will be described below.

When the valve member 71 contacts the valve seat 734, the distance D1 between the edge portion of the outer wall surface 712 facing in the contact direction and the edge portion of the outlet defining portion 733 facing in the contact direction is larger than the difference between the length D3 of the urging member 77 when the valve member 71 contacts the valve seat 734 and the compressed length D4 of the urging member 77.

According to this configuration, the outlet 733a is not opened at the time when the urging member 77 is fully compressed, and a fuel in a high pressure passage 34 keeps being prevented from flowing into the low pressure passage 33. Therefore, a force in the separation direction is put on the urging member 77 by a pressure of a fuel in the high pressure passage 34 even after the urging member 77 is fully compressed. Consequently, the urging member 77 is broken and loses an urging force urging the valve member 71 in the contact direction. The urging member 77 may push and move the holding member 72 in the separation direction, and accordingly the urging force urging the valve member 71 toward the contact direction is weakened. Consequently, the valve member 71 becomes easy to be opened by the pressure of a fuel in the high pressure passage 34 after the holding member 72 is moved by the valve member 71. The valve member 71 may become easy to move apart from the valve seat 134 by the pressure of the fuel in the high pressure passage 34 after the holding member 72 is once moved by the valve member 71.

### Third Embodiment

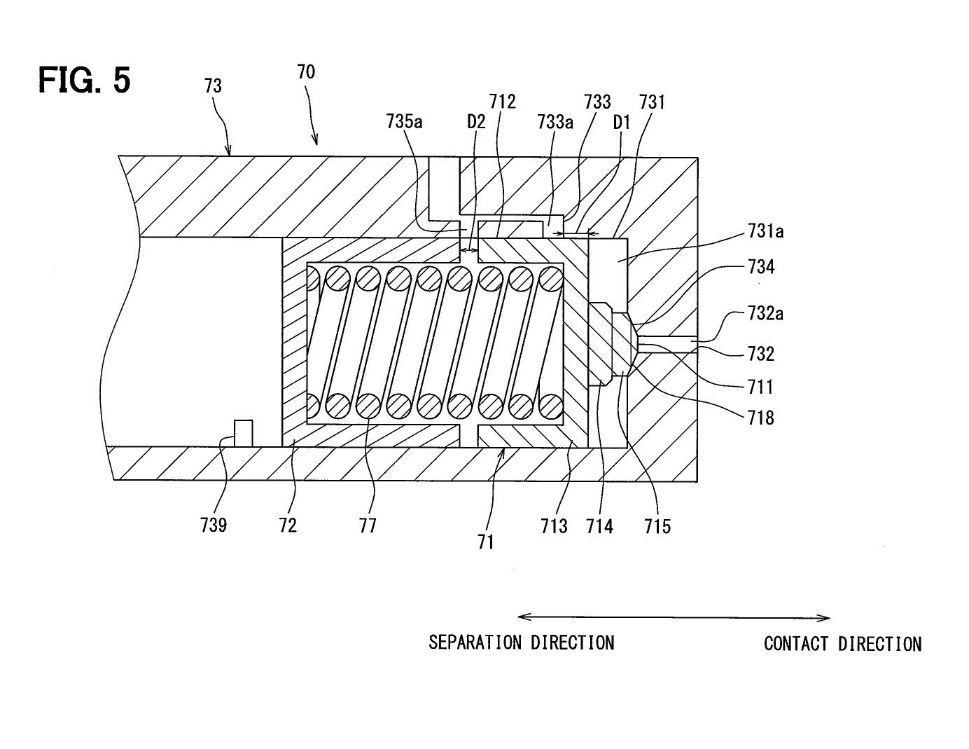

A pressure adjustment portion 70 according to a third embodiment includes a limiting portion 739 inside a body portion 73 located apart in a separation direction from a holding member 72 as shown in FIG. 5. The limiting portion 739 may be apart from the holding member 72 in the separation direction by a limitation distance that is set preliminarily. The limiting portion 739 is capable of limiting an excessive motion of the holding member 72 in the separation direction. Accordingly, a pressure that causes a valve member 71 to be opened after the holding member 72 is once moved by the valve member 71 within a range below an upper limit pressure at which the valve member 71 is opened at first time. A pressure that causes the valve member 71 to move in the separation direction after the holding member 72 is once moved by the valve member 71 may be set within the range below the upper limit pressure at which the valve member 71 is moved in the separation direction at first time.

A through-hole 735a is provided in the body portion 73. When the valve member 71 contacts a valve seat 734, a low pressure passage 33 and a space between the valve member 71 and the holding member 72 communicate with each other through the through-hole 735a.

According to this, a space enclosed by the holding member 72 and the valve member 71 is unlikely sealed airtightly. Therefore, when the valve member 71 moves in the separation direction, a fluid or an air in the space enclosed by the holding member 72 and the valve member 71 flows into the low pressure passage 33 through the through-hole 735a. Thus, a motion of the valve member 71 in the separation direction can become unlikely to be interfered by the fluid or the air in the space enclosed by the holding member 72 and the valve member 71.

Although the present disclosure has been fully described in connection with the preferred embodiments thereof with reference to the accompanying drawings, it is to be noted that various changes and modifications will become apparent to those skilled in the art.

In the above-described embodiments, a concave (notch) 721 may be provided on an end surface of the holding member 72 facing in the separation direction. The concave 721 may be located in a portion of the end surface of the holding member 72 facing in the separation direction corresponding to a portion of an end surface of the holding member 72 facing in the contact direction, in which the urging member 77 contacts the holding member 72. The concave 721 may be a groove recessed in a thickness direction or a hole extending through the holding member 72 in the thickness direction. The thickness direction may correspond to the axial direction of the body portion 73.

According to this, a force is put on the holding member 72 in the separation direction by the urging member 77 after the urging member 77 is fully compressed, and the end surface of the holding member 72 in the separation direction is pierced by the urging member 77. Consequently, the urging member 77 loses an urging force urging the valve member 71 in the contact direction.

In the above-described first to third embodiments, the pressure adjustment portion 70 is provided between the high pressure passage 34 and the low pressure passage 33, but the pressure adjustment portion 70 is not limited to this. For example, the pressure adjustment portion 70 may be provided between the high pressure passage 34 and the pressurization room 42, and return a fuel in the high pressure passage 34 to the pressurization room 42. The pressurization room 42 may be used as the upstream passage.

Additional advantages and modifications will readily occur to those skilled in the art. The disclosure in its broader terms is therefore not limited to the specific details, representative apparatus, and illustrative examples shown and described.

What is claimed is:

1. A high pressure pump comprising:
a pressurization portion including a pressurization room whose volume is varied by a motion of a plunger to be capable of pressurizing a fuel;
a discharge portion discharging the fuel pressurized in the pressurization room to a downstream passage that is a space on a downstream side of the discharge portion;
a body portion including:
a relief passage defining portion that defines a relief passage through which the fuel flows from the downstream passage to an upstream passage that is a space on an upstream side of the discharge portion;
an inlet defining portion that defines an inlet through which the relief passage and the downstream passage communicate with each other;
a valve seat that is provided on a radially outer side of the inlet and has an annular shape; and
an outlet defining portion that defines an outlet through which the relief passage and the upstream passage communicate with each other;
a valve member reciprocatably provided in the body portion, an outer wall of the valve member slidably contacting an inner wall of the body portion, the valve member contacting the valve seat so as to close the inlet of the body portion when a pressure in the downstream passage is below a predetermined pressure, the valve member moving apart from the valve seat in a separation direction so as to open the inlet of the body portion when the pressure in the downstream passage is at or above the predetermined pressure;
a holding member positioned apart in the separation direction by a second distance from the valve member when the valve member contacts the valve seat, an outer wall of the holding member contacting the inner wall of the body portion; and,
an urging member having a first end contacting the valve member and a second end contacting the holding member, the urging member urging the valve member toward the valve seat, wherein
the outlet of the body portion is located apart in the separation direction from the inlet of the body portion,
the valve member includes an outer wall surface closing the outlet of the body portion, and
when the valve member contacts the valve seat, a first distance between an edge portion of the outer wall surface of the valve member facing in a contact direction opposite from the separation direction and an edge portion of the outlet defining portion facing in the contact direction is larger than the second distance between the valve member and the holding member.

2. The high pressure pump according to claim 1, wherein when the valve member contacts the valve seat, a gap between the valve member and the holding member communicates with the outlet of the body portion.

3. The high pressure pump according to claim 1, further comprising a limiting portion being positioned apart from the holding member by a limitation distance and limiting a motion of the holding member in the separation direction.

4. A high pressure pump comprising:
a pressurization portion including a pressurization room whose volume is varied by a motion of a plunger to be capable of pressurizing a fuel;
a discharge portion discharging the fuel pressurized in the pressurization room to a downstream passage that is a space on a downstream side of the discharge portion;
a body portion including:
a relief passage defining portion that defines a relief passage through which the fuel flows from the downstream passage to an upstream passage that is a space on an upstream side of the discharge portion;
an inlet defining portion that defines an inlet through which the relief passage and the downstream passage communicate with each other;
a valve seat that is provided on a radially outer side of the inlet and has an annular shape; and
an outlet defining portion that defines an outlet through which the relief passage and the upstream passage communicate with each other;
a valve member reciprocatably provided in the body portion, an outer wall of the valve member slidably contacting an inner wall of the body portion, the valve member contacting the valve seat so as to close the inlet of the body portion when a pressure in the downstream passage is below a predetermined pressure, the valve member moving apart from the valve seat in a separation direction so as to open the inlet of the body portion when the pressure in the downstream passage is at or above the predetermined pressure;
a holding member positioned apart in the separation direction by a second distance from the valve member when the valve member contacts the valve seat, an outer wall of the holding member contacting the inner wall of the body portion; and,
an urging member having a first end contacting the valve member and a second end contacting the holding member, the urging member urging the valve member in an urging direction toward the valve seat, wherein
the outlet of the body portion is located apart in the separation direction from the inlet of the body portion,
the valve member includes an outer wall surface closing the outlet of the body portion,
when the valve member contacts the valve seat, a distance between an edge portion of the outer wall surface facing in the contact direction and an edge portion of the outlet defining portion facing in the contact direction is defined as a first distance, and a length of the urging member in the urging direction is defined as a first length,
when the urging member is fully compressed, a length of the urging member in the urging direction is defined as a second length, and
the first distance is larger than a difference between the first length and the second length.

5. The high pressure pump according to claim 4, wherein
the holding member includes a contact portion contacting the urging member, and
a portion of the holding member corresponding to the contact portion includes a groove recessed in a thickness direction or a hole extending through the holding member in the thickness direction.

6. The high pressure pump according to claim 1, wherein the holding member is movable in the separation direction.

7. The high pressure pump according to claim 1, wherein
the outer wall surface of the valve member closes the outlet of the body portion when the valve member contacts the valve seat, and
the outer wall surface slidably contacts the inner wall of the body portion.

8. The high pressure pump according to claim 4, wherein
the urging member is a spring, and
the second length is a solid height of the spring.

9. The high pressure pump according to claim 6, wherein
the holding member moves in the separation direction when a pressure in the relief passage is at or above the predetermined pressure, and
the holding member does not move in the separation direction when the pressure in the relief passage is below the predetermined pressure.
